(19) United States
(12) Patent Application Publication
(10) Pub. No.: US 2007/0002561 A1
(43) Pub. Date: Jan. 4, 2007

(54) Solar powered lighting system

(76) Inventors: Mark W. Tesmer, Liberty Township, OH (US); Arthur John Heppner, Lake Villa, IL (US); Luis Ruben Allende, Wildwood, IL (US)

Correspondence Address: Mark W. Tesmer, 5700 Rutledge Trail, Liberty Township, OH, 45011, US

(21) Appl. No.: 11/171,984

(22) Filed: Jul. 1, 2005

(51) Int. Cl. F21L 4/00

(52) U.S. Cl. 362/183; 362/153; 362/276

(57) ABSTRACT

An outdoor battery operated lighting system includes a solar panel for recharging a battery contained in a junction box. The junction box has a depending rod thereon for being rammed into the ground to obtain a self-standing lighting system. The junction box also two lateral flexible arms attached thereto for movably adjusting the light beams of lamp heads attached at the ends of each of the arms. The junction box also has an upstanding tube thereon which has a sola panel attached at its top. The upstanding tube contains a ball joint therein so that the solar panel can be directed into different directions to best utilize the sun's rays. A timing circuit is included in the junction box which turns off the lighting circuit in inclement weather to conserve the energy level of the battery.

### FIELD OF THE INVENTION

This Invention relates to an on site lighting system that can be used to direct light onto signs on a temporary or a permanent basis. It can be used to lighten foot paths in a business or a residence. It can be used to direct light onto certain features of a building. The lighting system can also be used on boats without having to use the boat battery so as not to drain the power.

### BACKGROUND OF THE INVENTION

It is very important to have a portable lighting system in areas were certain features should be illuminated in the dark and where no standard electricity is available or is not feasible to install. Such features can be sign of Realtors that should be illuminated at night, after dusk, so that the advertised residence or business is readily visible to a passerby or to an individual having an appointment for viewing the residence.

US Patent Application Publication No. 2004/0177538 illustrates a solar powered sign light which is self contained with two solar collectors on top of the unit including downwardly directed light bulbs that illuminate the sign when the unit is placed on top of a sign support.

U.S. Design Pat. No. 378,143 discloses a portable solar powered lighting system that is placed on top of an arm that supports a sign. There are two self contained lights each supported by an arm that is fastened to a basic support clamp to the above mentioned arm. Each of the lights has a solar collector cell on top and a prismatic lens on the bottom which is directed toward the surface of the sign. The prismatic lens is at the bottom and below the cell to be directed toward a surface of the sign to be illuminated.

### BRIEF DESCRIPTION AND OBJECTS OF THE INVENTION

An object of the invention is to create a portable and versatile battery powered lighting system that can be attached to signs to illuminate the same or can be used as a stand-alone unit to illuminate side walks or features of a building when it is dark in the immediate area. The lighting system consists of a solar collector that can be trained toward the sun in its most effective direction. The solar collector is movably mounted on a junction box. Two flexible arms are mounted laterally from the junction box to be most effectively trained on to the surface of a sign without obstructing the same or they flexible arms can be trained or directed toward an object to be illuminated. The lighting system contains a timing unit that can turn off the system in inclement weather.

### BRIEF DESCRIPTION OF THE DRAWINGS

FIG. 1 is a perspective view of the inventive solar lighting system;

FIG. 2 is a schematic of a timing circuit.

### DETAILED DESCRIPTION OF THE INVENTION

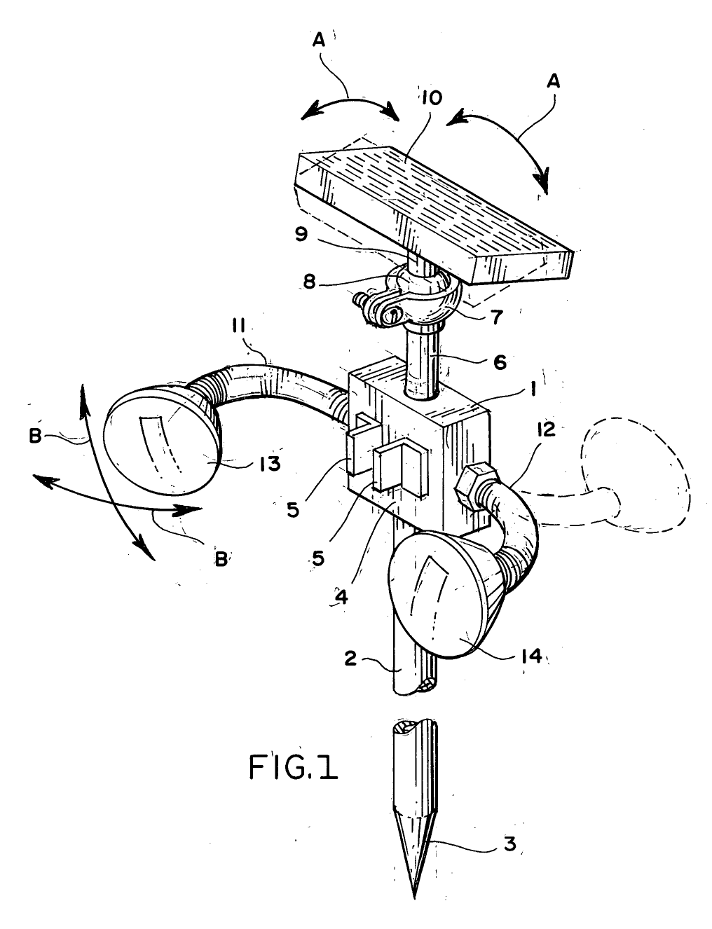

FIG. 1 illustrates the lighting system where 1 is a junction box that can have a removable downwardly depending rod or post 2 attached thereto that can be rammed into the ground by way of the pointed bottom end 3. At 4 is shown a frontal surface of the junction box 1 that is designed to receive a bracket assembly shown with two flanges 5/5. If a sign is to be lighted that is standing by itself and on its own, the bottom rod 2 can be removed from the junction box and the junction box can be directly attached to the sign by way of a bracket assembly 5/5. Of course, the bracket 5/5 can be any design choice different from the one shown.

The junction box 1 has an upstanding tube 6 attached thereto which has a ball joint clamp 7 attached thereto.

This adjustable clamp encircles a ball 8 which is attached to a further upstanding tube 9. On top of the further upstanding tube 9 there is mounted a solar energy panel 10 which contains photo voltaic cells which will receive the sunlight to create an electric current, which is well known. The interposition of the ball joint 8 assures that the solar panel can always be trained (arrows A) in a direction to receive the most beneficial UV rays of the sun capable of recharging the onboard batteries.

On each side of the Junction box are each mounted lateral arms 11 and 12 which carry light emitting light heads 13 and 14 at each end thereof. The light heads 13 and 14 each contain a set of at least three LED (Light Emitting Diodes) lights and a reflective concave shaped lens to focus lighting on a desired object. Each of the arms 11 and 12 is flexible in all directions so that the light heads can be trained in all directions (arrows B). This is extremely important in the inventive lighting system. This way the lighting system, wherever it is installed, can illuminate different subjects at the same time, for example.

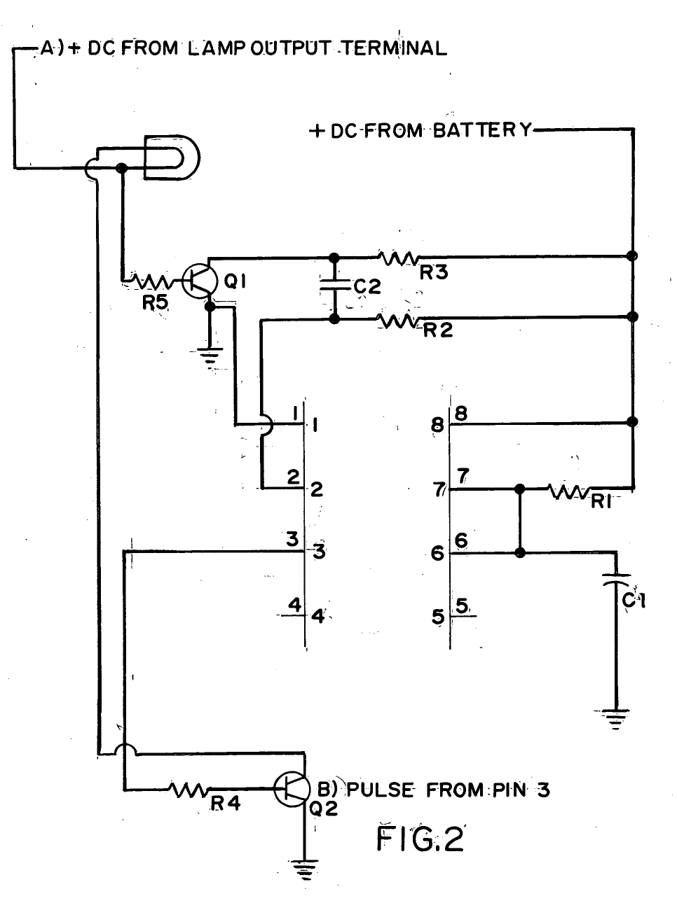

All components and wiring are weather proof and suitable for any outdoor application or use. The integrated components (circuit of FIG. 2) are all contained within the gjunction box 1. The junction box 1 will also contain an integrated sensing device which will detect changes in ambient lighting, from bright to dim/dark and will control the battery voltage supplied to the LED lights.

FIG. 2 illustrates a timing schematic depicting a circuit that controls the off and on state of the lighting system. This circuit will activate when the solar light level falls below a predetermined threshold.

Component Specifications:

| | |
|---|---|
| R1 = | 8 meg. Ohm |
| R2, R3 = | 100k Ohm |
| R4, R5 = | 3k Ohm |
| C1 = | 1200 uf |
| C2 = | .1 uf |
| Q1, Q2 = | 2n222 - (NPN or Equiv.) |

Component Description

| | |
|---|---|
| R1-R4 = | Carbon Film Resistor/5% Tolerance or better |
| C1 = | Capacitor Polarized Electrolytic |
| C2 = | Capacitor Tantalum |
| Q1, Q2 = | Transistor NPN Standard Switching Type |
| IC 1 = | TLC555 - Low power timer IC with free air operating range |
| | of −40° to +125° C. |

The numerals 1-8 represent pins or test contact points.

With reference to A), when light levels fall below a predetermined threshold, solar panel controls set this line (+DC). This turns on Q1 causing a momentary negative pulse at pin 2 and triggering a positive output pulse on pin 3, whose length is determined by R1, C1.

With reference to B), the output pulse at pin 3 turns on Q2 which completes the circuit for a lighting array. After the pulse has completed, Q2 turns off and the lighting array is deactivated. Daylight causes A) to turn off which in turn shuts off Q1, resetting the circuit.

What we claim is:

1. A solar powered lighting system including a junction box, said junction box has a depending rod thereon adapted to be rammed in the ground, The junction box further has an upstanding tube, said tube movably supporting a solar panel thereon, said junction box further supporting at least two flexible arms thereon, said at least two arms having each a projection light attached thereto at each end of said two arms.

2. The lighting system of claim 1, wherein said tube movably supporting said solar panel includes a ball joint connection.

3. The lighting system of claim 1, wherein said depending rod is removably attached to said junction box.

4. The lighting system of claim 1 including a bracket assembly on one side of said junction box for attaching said junction box to a sign.

5. The lighting system of claim 1 including a timer contained within said junction box.

6. The lighting system of claim 5 including a standard transistor switch which is turned on when a light level falls below a predetermined threshold to thereby trigger a positive DC output pulse, the length of said output pulse is determined by a carbon film resistor and a first polarized electrolytic capacitor, said output pulse turns on a second polarized electrolytic capacitor which completes a circuit for the light array.

7. A timing circuit for activating or deactivating a battery operated lighting circuit, said circuit includes a standard transistor switch which is turned on when a light level falls below a predetermined threshold to thereby trigger a positive DC output pulse, the length of said output pulse is determined by a carbon film resistor and a first polarized electrolytic capacitor, said output pulse turns on a second polarized electrolytic capacitor which completes a circuit for the light array.

8. The timing circuit of claim 7, including when said circuit for said light array is completed, the lighting array is deactivated, after daylight is reestablished, the transistor switch is shut off to thereby reset said circuit of said lighting circuit.
